(19) United States
(12) Patent Application Publication
(10) Pub. No.: US 2005/0029409 A1
(43) Pub. Date: Feb. 10, 2005

(54) Din stereo slot mountable automobile gauge cluster

(76) Inventor: Nestor Tagle, Corona, CA (US)

Correspondence Address: Vic Y. Lin;MYERS DAWES ANDRAS & SHERMAN LLP, 19900 MacArthur Blvd., 11th Floor, Irvine, CA, 92612, US

(21) Appl. No.: 10/634,519

(22) Filed: Aug. 4, 2003

(51) Int. Cl. G12B 9/00

(52) U.S. Cl. 248/27.1

(57) ABSTRACT

A method for mounting a gauge cluster in an automobile includes connecting at least one wire of the gauge cluster to at least one wire of the automobile, so as to facilitate electrical communication between the automobile and the gauge cluster, and inserting the gauge cluster into a DIN stereo slot of the automobile.

### FIELD OF THE INVENTION

The present invention relates generally to automobile gauges and relates more particularly to a convenient and low cost method for mounting gauges in an automobile which provides aesthetically pleasing results.

### BACKGROUND OF THE INVENTION

Gauges for displaying operating parameters for automobiles are well known. Such gauges display operating parameters such as battery/alternator voltage, water temperature and oil pressure. Various other operating parameters may also be displayed. Operating parameters are typically monitored by a driver of the automobile to assure that the engine thereof is operating properly.

Gauges may be either analog or digital. Analog gauges typically have a needle which points to a numerical value on a scale which is printed or otherwise formed upon the face of the gauge. For example, in an automobile for which the battery charging system is operating properly, the needle of such an analog gauge will point to approximately 12.4 volts on the scale thereof.

Many digital gauges display the numeric value of the monitored parameter directly. That is, numerals are generally displayed in a digital readout, such as a liquid crystal display (LCD). For example, in the automobile mentioned above the numerals 12.4 would be displayed on the digital voltmeter thereof. Digital gauges are often considered to be more accurate and easier to read when compared to analog gauges, and are thus frequently preferred.

Many automobiles are provided by the manufacturer with indicator lights instead of gauges or with inadequate or otherwise undesirable gauges. Indicator lights are sometimes not desired because they only provide the driver with an indication as to whether a particular operating parameter is within preset tolerances or not. Many drivers prefer to know the actual value of the operating parameter. Knowing the actual value of the operating parameter provides a better indication of performance and may alert the driver to an undesirable condition before the operating parameter is actually out of tolerance.

Some original equipment gauges may be considered inadequate because they are not sufficiently accurate or because they are aesthetically displeasing.

Thus, a driver will sometimes desire to add gauges (such as when only indicators lights are originally provided) or will desire to change gauges (such as when gauges other than those originally provided are wanted). There is a substantial market for aftermarket gauges to fulfill these desires.

However, as those skilled in the art will appreciate, adding gauges to an automobile sometimes poses certain problems. One of these problems is that of how to mount the new gauges.

Occasionally, aftermarket gauges can be mounted in the opening where the original equipment gauges were previously mounted. However, this is not always possible. For example, the aftermarket gauges may be larger than the original equipment gauges and thus may not fit into the original openings.

It is also possible that the driver may not want to mount the new gauges in the original opening even if this can be accomplished. For example, the driver may not like the location of the original gauges.

Aftermarket automobile gauges can be mounted to the dashboard, console, or other structure within the cabin of an automobile by using mounting brackets. Indeed, gauge clusters, containing a plurality of gauges, can be mounted in this manner.

However, such bracket mounting of aftermarket gauges or gauge clusters has several inherent deficiencies which detract from its usefulness and desirability. For example, it is not always possible to define a location for bracket mounting which is acceptable to the driver. For aesthetic, practical, or other reasons, the driven may be dissatisfied with the potential mounting locations of bracket mounted aftermarket gauges.

Additionally, mounting gauges via brackets within an automobile requires tools and some degree of skill. Not all drivers have the required tools and/or skill, thus necessitating that they employ the service of someone who has the required tools and skill.

Thus, although such contemporary methods for mounting aftermarket gauges have proven generally suitable for their intended purposes, they possess inherent deficiencies which detract from their overall effectiveness and desirability.

As such, although the prior art has recognized, to a limited extent, the problem of mounting aftermarket gauges within an automobile, the proposed solutions have, to date, been ineffective in providing a satisfactory remedy. Therefore, it is desirable to provide aftermarket gauges and gauge clusters which can be easily mounted in a desirable location without the use of tools and with little skill.

### BRIEF SUMMARY OF THE INVENTION

While the apparatus and method has or will be described for the sake of grammatical fluidity with functional explanations, it is to be expressly understood that the claims, unless expressly formulated under 35, USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

The present invention specifically addresses and alleviates the above mentioned deficiencies associated with the prior art. More particularly, according to one aspect the present invention comprises a method for mounting a non-stereo item in an automobile, wherein the method comprises inserting the non-stereo item into a DIN stereo slot of the automobile.

According to another aspect, the present invention comprises a method for mounting at least one gauge in an automobile, wherein the method comprises inserting the gauge(s) into a DIN stereo slot of the automobile.

According to another aspect, the present invention comprises a method for mounting a gauge cluster in an automobile, wherein the method comprises inserting the gauge cluster into a DIN stereo slot of the automobile.

According to another aspect, the present invention comprises a method for mounting a gauge cluster in an automobile, wherein the method comprises connecting at least one wire of the gauge cluster to at least one wire of the automobile, so as to facilitate electrical communication between the automobile and the gauge cluster, and inserting the gauge cluster into a DIN stereo slot of the automobile.

According to another aspect, the present invention comprises a non-stereo device comprising an enclosure that is configured for mounting into a DIN stereo slot of an automobile.

According to another aspect, the present invention comprises a gauge comprising an enclosure that is configured for mounting into a DIN stereo slot of an automobile.

According to another aspect, the present invention comprises a gauge cluster comprising an enclosure that, is configured for mounting into a DIN stereo slot of an automobile.

According to another aspect, the present invention comprises a gauge cluster comprising a plurality of gauges and an enclosure. The enclosure is configured for mounting into a DIN stereo slot of the automobile.

According to another aspect, the present invention comprises a method for manufacturing a gauge cluster, wherein the method comprises forming an enclosure of the gauge cluster that is configured for mounting within a DIN stereo slot of an automobile.

According to another aspect, the present invention comprises a, locking detent for facilitating mounting a device within a DIN stereo slot, of an automobile, wherein the locking detent comprises a leaf spring detent. A locking tab is formed upon the leaf spring detent and is configured to engage a portion of an automobile DIN stereo slot such that the device is locked into the DIN stereo slot when the leaf spring detent is extended and such that the device is not locked into the DIN stereo slot when the leaf spring detent is depressed.

These, as well as other advantages of the present invention, will be more apparent from the following description and drawings. It is understood that changes in the specific structure shown and described may be made within the scope of the claims, without departing from the spirit of the invention.

### BRIEF DESCRIPTION OF THE DRAWINGS

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

FIG. 1 is a perspective view of an automobile dashboard, showing an empty DIN stereo slot formed therein according to contemporary practice and showing the rack of the DIN stereo slot and a preferred gauge cluster of the present invention exploded from the DIN stereo slot;

FIG. 2 is a front view of the automobile dashboard of FIG. 1, showing the DIN stereo slot having a gauge cluster disposed therein according to the present invention;

FIG. 3 is a front perspective view of the gauge cluster of FIG. 1;

FIG. 4 is a back perspective view of the gauge cluster of FIG. 1;

FIG. 5 is an enlarged top view, partially in cross-section, of the gauge cluster of FIG. 1, showing the leaf spring locking detent thereof in a depressed position, such that removal of the gauge cluster from the DIN stereo slot is facilitated;

FIG. 6 is an enlarged top view, partially in cross-section, of the gauge cluster of FIG. 1, showing the leaf spring locking detent thereof in an extended position, such that engagement of the leaf spring detent locking tab with a side opening of the DIN stereo slot rack inhibits removal of the gauge cluster from the DIN stereo slot; and

FIG. 7 is a front view of an alternative embodiment of the gauge cluster of the present invention having a generally oval bezel.

### DETAILED DESCRIPTION OF THE PREFERRED EMBODIMENTS

Many alterations and modifications may be made by those having ordinary skill in the art without departing from the spirit and scope of the invention. Therefore, it must be understood that the illustrated embodiments have been set forth only for the purposes of example and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in, this specification to describe the invention and its various embodiments are to be understood not only in the, sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that are also intended to be encompassed within the spirit of the invention.

According to one aspect, the present invention comprises a method for mounting a non-stereo item in an automobile, wherein the method comprises inserting the non-stereo item into a DIN stereo slot of the automobile.

DIN stands for Deutsche Industrie Normen. Deutsch Industrie Normen provides industry standards industry standards for the dimensions of such items as automobile compact disc players and stereo receivers. Such standards assure, for example, that when you purchase a stereo for you automobile, that the stereo fits into the slot provided in the console of the automobile.

According to another aspect, the present invention comprises a method for mounting at least one gauge in an automobile, wherein the method comprises inserting the gauge(s) into a DIN stereo slot of the automobile.

According to another aspect, the present invention comprises a method for mounting a gauge cluster in an automobile, wherein the Method comprises inserting the gauge cluster into a DIN stereo slot of the automobile.

According to another aspect, the present invention comprises a method for mounting a gauge cluster in an automobile, wherein the method comprises connecting at least one wire of the gauge cluster to at least one wire of the automobile, so as to facilitate electrical communication between the automobile and the gauge cluster, and further comprises inserting the gauge cluster into a DIN stereo slot of the automobile. Preferably, connecting at least one wire comprises connecting a plurality of wires.

Preferably, inserting the gauge cluster into a DIN stereo slot comprises inserting the gauge cluster into a DIN stereo slot which is nominally the same size as the gauge cluster.

Preferably, the DIN stereo slot comprises one of a 1″ DIN stereo slot, a 1.5″ DIN stereo slot, a 2″ DIN stereo slot and a 3″ DIN stereo slot. Preferably, the DIN stereo slot comprises a 2″ DIN stereo slot. As those skilled in the art will appreciate, various other sizes of DIN stereo slot may be available or may become available in the future. The use of other sizes of DIN stereo slots is contemplated herein.

Preferably, the gauge cluster comprises at least one gauge having a digital readout. Preferably, the gauge cluster comprises a plurality of gauges having digital readouts. Preferably, the gauge cluster comprises a voltage gauge, an oil pressure gauge, and a water temperature gauge.

Inserting the gauge cluster into a DIN stereo slot of the automobile preferably comprises inserting the gauge cluster into the DIN stereo slot such that at least one detent inhibits removal of the gauge cluster from the DIN stereo slot. The detent is preferably formed upon the gauge cluster. However, as those skilled in the art will appreciate, the detent may alternatively be formed upon or within the DIN stereo slot.

Preferably, at least one detent locks the gauge cluster in the DIN stereo slot. Thus, the detent inhibits inadvertent removal of the gauge cluster from the DIN stereo slot, such as by the shock or vibration of the automobile which inevitably occurs during driving and such as by children or others tugging at or playing with the gauge cluster.

One or more sensors that are electronically compatible with corresponding gauges of the gauge cluster are installed in the automobile. For example, a water temperature sensor may be installed in the cooling system of the automobile's engine and thus may provide an electronic output which is compatible with the water temperature gauge of the gauge cluster. In a similar fashion, an oil pressure sensor may be installed in the oil system of the automobile's engine and thus may provide an electronic output which is compatible with the oil pressure gauge of the gauge cluster.

According to another aspect, the present invention comprises a non-stereo device which comprises an enclosure that is configured for mounting into a DIN stereo slot of an automobile.

According to another aspect, the present invention comprises a gauge which comprises an, enclosure that is configured for mounting into a DIN stereo slot of an automobile.

According to another aspect, the present invention comprises a gauge cluster which comprises an enclosure that is configured for mounting into a DIN stereo slot of an automobile.

According to another aspect, the present invention comprises a gauge cluster which comprises a plurality of gauges and an enclosure, wherein the enclosure is configured for mounting into a DIN stereo slot of the automobile.

Preferably, at least one metallic leaf spring detent is formed upon the enclosure of the gauge cluster and is configured to inhibit removal of the gauge cluster from the DIN stereo slot.

Preferably, at least one locking detent is formed upon the enclosure of the gauge cluster and each of the locking detent is preferably comprises a leaf spring detent and a locking tab formed upon the leaf spring detent. The locking detent is preferably configured to engage a portion of an automobile DIN stereo slot such that the gauge cluster is locked into the DIN stereo slot when the leaf spring detent is extended and such that the gauge cluster is not locked into the DIN stereo slot when the leaf spring detent is depressed.

The gauge cluster preferably comprises a bezel configured to limit movement of the gauge cluster into the DIN stereo slot. According to one embodiment of the present invention, the bezel is generally rectangular in shape. According to another embodiment of the present invention, the bezel is generally oval in shape. Those skilled in the art will appreciate that the bezel may be of any desire shape.

According to another aspect, the present invention comprises a method for manufacturing a gauge cluster, wherein the method comprises forming an enclosure of the gauge cluster that is configured for mounting within a DIN stereo slot of an automobile.

According to another aspect, the present invention comprises a locking detent for facilitating mounting a device within a DIN stereo slot of an automobile, wherein the locking detent comprises a leaf spring detent and a locking tab formed upon the leaf spring detent and configured to engage a portion of an automobile DIN stereo slot such that the device is locked into the DIN stereo slot when the leaf spring detent is extended and such that the device is not locked into the DIN stereo slot when the leaf spring detent is depressed. The locking tab is preferably formed by bending a portion of the leaf spring away from the remainder of leaf spring.

The present invention is illustrated in FIGS. 1-7, which depict presently preferred embodiments thereof.

Referring now to FIG. 1 the dashboard 11 of an automobile typically has a DIN stereo slot 12 formed therein. Although the DIN stereo slot 12 will generally be described herein as being formed in the dashboard 11, those skilled in the art Will appreciate that the DIN stereo slot 12 may alternatively be formed in the console of an automobile. Indeed, in some instances the dashboard may be somewhat indistinguishable from the console at the location where the DIN stereo slot is formed. For the purposes of this patent application, it does not matter where the DIN stereo slot is located. Thus, discussion of the DIN stereo slot 12 as being located in the dashboard 11 of an automobile is by way of example only, and not by way of limitation.

The DIN stereo slot 12 typically comprises a sheet metal cage or rack 32, which is shown exploded from the dashboard 11. The rack 32 generally remains within the dashboard 11 and is not typically removed therefrom in the practice of the present invention. However, if a rack 32 is not already installed in the DIN stereo slot 12, then one may be provided and installed along with the gauge cluster 14. The rack 32 is shown exploded from the dashboard 11 in order to illustrate the relationship between the rack 32 (particularly the opening 24 formed therein), and the opening defining the remainder of the DIN stereo slot 12.

DIN stereo slots have a nominal width, dimension A, of 7⅛ inches and have exemplary nominal heights, Dimension B, of 1 inch, 1 1/2 inch, 2 inches, and 3 inches. Other DIN stereo slot dimensions are possible. Moreover, DIN stereo slots can generally have any height from ½ inch to 5 inches in ½ inch increments. Dimensions A and B are the inside dimensions of the rack 32.

According to contemporary practice, DIN stereo slots having different heights are used for stereo components similarly having different heights and for stacking of stereo components. For example, a DIN stereo slot having a height of 3 inches may be used to mount either a single 3 inch high stereo, component, two 1½, inch high stereo components, a single 1 inch high stereo component and a single 2 inch high stereo component, or three 1 inch high stereo components.

According to the present invention, one or more gauge clusters may be installed within a single DIN stereo slot. For example, a DIN stereo slot having a height of 3 inches may be used to mount either a single 3 inch high gauge cluster, two 1½ inch high gauge clusters, a single 1 inch high gauge cluster and a single 2 inch high gauge cluster, or three 1 inch high gauge clusters.

According to the present invention, a gauge or a gauge cluster is' configured so as to be inserted into a DIN stereo slot. The description herein generally refers to a gauge cluster. However, as those skilled in the art will appreciate, the description herein similarly applies to a single gauge as well. Thus, in the description herein, the term “gauge” may generally be substituted for “gauge cluster”.

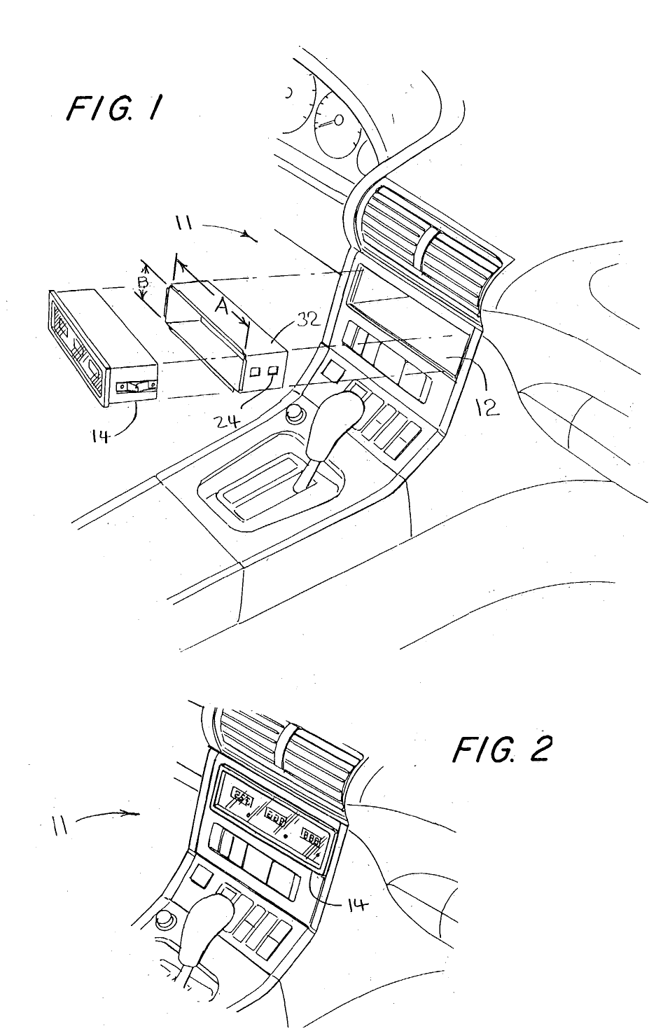

Referring now to FIG. 2, a gauge cluster 14 of the present invention is installed in the DIN stereo slot 12′. The gauge cluster 14 may comprise one, two, three, four or any desired number of gauges. Preferably, the nominal size of the gauge cluster 14 is the same as the nominal size of the DIN stereo slot 12. However, the nominal size of the gauge cluster 14 may alternatively by smaller than the nominal size of the DIN stereo slot 12.

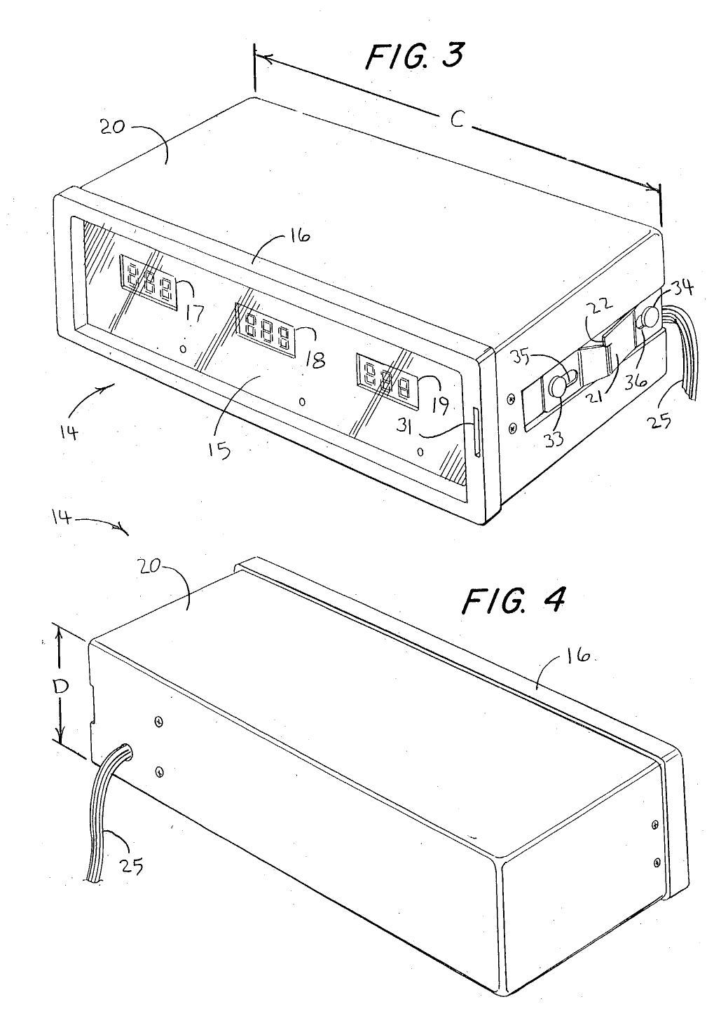

Referring now to FIGS. 3 and 4, the gauge cluster 14 thus preferably has a nominal width, Dimension C, which matches the nominal width, Dimension A, of the DIN stereo slot 12. Similarly, the gauge cluster 14 preferably has a nominal height, Dimension D, which matches the nominal height, Dimension B, of the DIN stereo slot 12. However, the dimensions of the gauge cluster 14 do not have to match the dimensions of the DIN stereo slot 12. Rather, it is necessary that one or more gauge clusters 14 fit within the DIN stereo slot 12.

The actual (as opposed to nominal) dimensions of the gauge cluster 14 of the present invention are preferably slightly smaller than the corresponding actual dimensions of the DIN stereo slot 12, such that the gauge cluster 14 can easily be inserted into the DIN stereo slot 12.

The gauge cluster 14 comprises a faceplate 15, a bezel 16 generally surrounding the faceplate 15, a plurality of gauges 17-19 extending through or disposed behind the faceplate 15, and an enclosure 20 within which the gauges 17-19 are disposed. Of course, if the gauges are disposed behind the faceplate 15, then a transparent or translucent faceplate 15 is utilized.

The bezel 16 may be either formed separately with respect to the enclosure 20 or may alternatively be formed integrally therewith. The bezel 16, if formed separately with respect to the enclosure 20, may be attached thereto via the use of fasteners, adhesive bonding, ultrasonic welding, or via any other desired method. Both the bezel 16 and the enclosure 20 are preferably formed of a durable polymer material.

The bezel 16 is optional and thus need not be used at all. If used, the bezel 16 may be removable from the gauge cluster 14 and may be snapped in place thereon according to well known principles.

The bezel 16 may have any desired cross-sectional configuration, including a square, rounded, or other cross-sectional configuration.

The gauges 17-19 may be mounted within the enclosure 20 via fasteners, adhesive bonding, ultrasonic welding, or via any other desired method.

At least on wire 25 extends from the enclosure 20 and facilitates electrical communication between the gauges 17-19 and sources of signals for the gauges 17-19, according to well known principles.

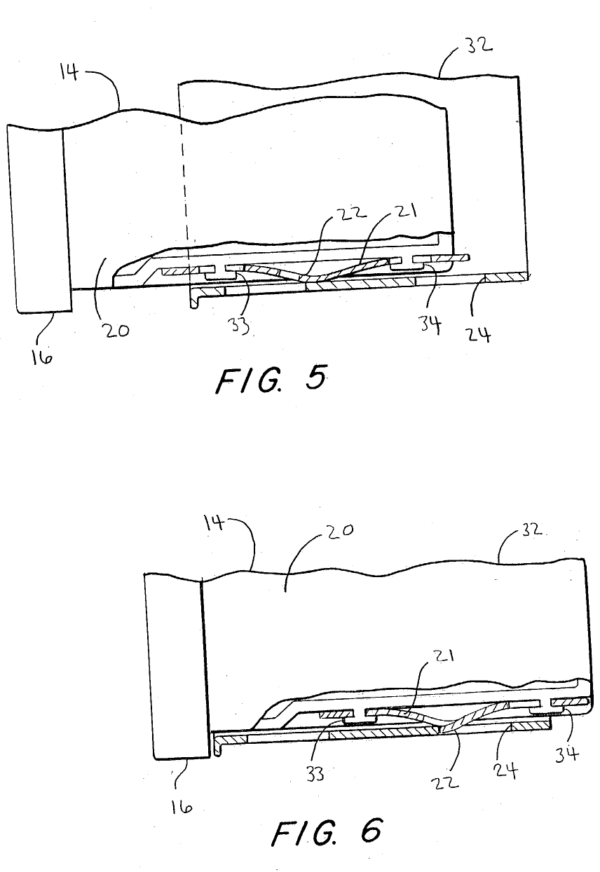

Referring now to FIGS. 5 and 6, a leaf spring detent 21 is attached to one or more sides of the enclosure 20. Each leaf spring detent 21 is spring biased outwardly so as to press against a side of the DIN stereo slot 12 in a manner which tends to keep the gauge cluster 14 within the DIN stereo slot 12 after the gauge cluster 14 has been inserted thereinto. Preferably, the leaf spring detent(s) press against the rack 32 of the DIN stereo slot 12.

Optionally one or more of the leaf spring detents 21 have a locking tab 22 (best shown in FIGS. 3 and 6) formed thereon so as to lock the gauge cluster 14 within the DIN stereo slot 12 after the gauge cluster 14 has been inserted thereinto. Thus, the combination of the locking tab 22 with the leaf spring detent 21 defines a least one metallic leaf spring locking detent. Preferably, the leaf spring detent 21 and locking tab 22 are configured such that the leaf spring detent 21 can be depressed so as to facilitate removal for the gauge cluster 14 from the DIN stereo slot 12.

For example, the leaf spring detent 21 and the locking tab 22 may be configured such that the leaf spring detent 21 can be depressed by reaching beneath or behind the dashboard 11 and pressing in on the leaf spring detent 21, either with a finger or a tool. Alternatively, the leaf spring detent 21 and the locking tab 22 may be configured such that the leaf spring detent 21 can be depressed with a knife blade, shim, or other tool which is inserted through a slot 31 (shown in FIG. 3) formed in the bezel 16.

With particular reference to FIG. 6, it can be seen that engagement of the locking tab 22 with an edge of an opening 24 formed within the rack 32 of the DIN stereo slot 12 causes the gauge cluster 14 to be locked with the DIN stereo slot 12.

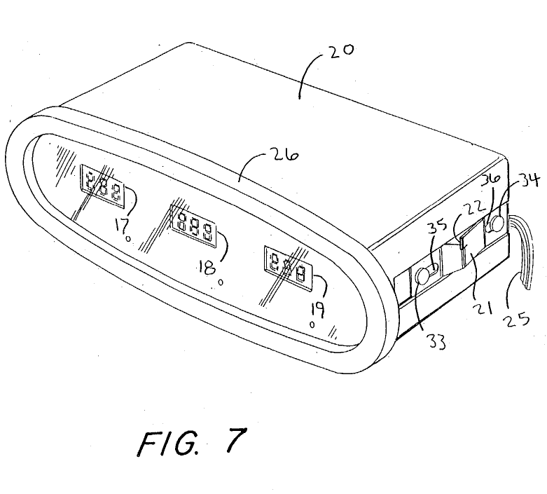

Referring now to FIG. 7, the bezel 26 may alternatively be generally oval in shape. Indeed, the bezel may be of any desired shape.

To install the gauge cluster 14 of the present invention into a DIN stereo slot 12, the wires 25 are typically connected to corresponding wires from the appropriate sensors of the automobile (typically from the engine) according to well know principles. Next, the gauge cluster 14 is inserted into the DIN stereo slot 12, preferably until the bezel 16, 26 thereof abuts the dashboard 11 at the entrance of the DIN stereo slot 12. In some instances, it may be preferred to insert the gauge cluster 14 into the DIN stereo slot 12 and then connect the wires 25. However, it will generally be much easier to connect the wires 25 before inserting the gauge cluster 14 into the DIN stereo slot 12.

Preferably, the gauge cluster 14 is inserted into the DIN stereo slot 12 at least to the point where the locking tab 22 engages the opening 24, so as to lock the gauge cluster within the DIN stereo slot 12.

The gauge cluster 14 may subsequently be removed from the DIN stereo slot 12, such as for replacement or maintenance thereof, by depressing the leaf spring detent 21 so as to disengage the locking tab 22 from the opening 24 of the DIN stereo slot 12, as discussed in detail above.

The present invention provides aftermarket gauges and gauge clusters which can be easily mounted in a desirable location without the use of tools and With little skill. If desired, the gauges and gauge clusters of the present invention may alternatively be installed in an automobile by the automobile manufacturer and thus need not be limited to aftermarket applications.

It is understood that the exemplary DIN stereo slot mountable automobile gauge cluster described herein and shown in the drawings represents only presently preferred embodiments of the invention. Indeed, various modifications and additions may be made to such embodiments without departing from the spirit and scope of the invention. For example, the enclosure need not be generally rectangular in configuration, as shown in the drawings. Rather, the enclosure may be of any desired shape and configuration. Thus, the enclosure may alternatively be generally oval or oblong in shape, or indeed, may have an irregular shape.

Thus, these and other modifications and additions may be obvious to those skilled in the art and may be implemented to adapt the present invention for use in a variety of different applications.

1. A method for mounting a non-stereo item in an automobile, the method comprising inserting the non-stereo item into a DIN stereo slot of the automobile.

2. A method for mounting at least one gauge in an automobile, the method comprising inserting the gauge(s) into a DIN stereo slot of the automobile.

3. A method for mounting a gauge cluster in an automobile, the method comprising inserting the gauge cluster into a DIN stereo slot of the automobile.

4. A method for mounting a gauge cluster in an automobile, the method comprising:
connecting at least one wire of the gauge cluster to at least one wire of the automobile, so as to facilitate electrical communication between the automobile and the gauge cluster; and
inserting the gauge cluster into a DIN stereo slot of the automobile.

5. The method as recited in claim 4, wherein connecting at least one wire comprises connecting a plurality of wires.

6. The method as recited in claim 4, wherein inserting the gauge cluster into a DIN stereo slot comprises inserting the gauge cluster into a DIN stereo slot of nominally the same size as the gauge cluster.

7. The method as recited in claim 4, wherein the DIN stereo slot comprises one of a 1″ high DIN stereo slot, a 1.5″ high DIN stereo slot, a 2″ high DIN stereo slot and a 3″ high DIN stereo slot.

8. The method as recited in claim 4, wherein the gauge cluster comprises at least one gauge having a digital, readout.

9. The method as recited in claim 4, wherein the gauge cluster comprises a plurality of gauges having digital readouts.

10. The method as recited in claim 4, wherein the gauge cluster comprises a voltage gauge, an oil pressure gauge, and a water temperature gauge.

11. The method as recited in claim 4, wherein inserting the gauge cluster into a DIN stereo slot of the automobile comprises inserting the gauge cluster into the DIN stereo slot such that at least one detent inhibits removal of the gauge cluster from the DIN stereo slot.

12. The method as recited in claim 4, wherein inserting the gauge cluster into a DIN stereo slot of the automobile comprises inserting the gauge cluster into the DIN stereo slot such that at least one detent formed upon the gauge cluster inhibits removal of the gauge cluster from the DIN stereo slot.

13. The method as recited in claim 4, wherein inserting the gauge cluster into a DIN stereo slot of the automobile comprises inserting the gauge cluster into the DIN stereo slot such that at least one detent locks the gauge cluster in the DIN stereo slot.

14. The method as recited in claim 4, wherein inserting the gauge cluster into a DIN stereo slot of the automobile comprises inserting the gauge cluster into the DIN stereo slot such that at least one detent formed upon the gauge cluster locks the gauge cluster in the DIN stereo slot.

15. The method as recited in claim 4, further comprising installing in the automobile at least one sensor that is electronically compatible with at least one gauge of the gauge cluster.

16. A non-stereo device comprising an enclosure that is configured for mounting into a DIN stereo slot of an automobile.

17. A gauge comprising an enclosure that is configured for mounting into a DIN stereo slot of an automobile.

18. A gauge cluster comprising an enclosure that is configured for mounting into a DIN stereo slot of an automobile.

19. A gauge cluster comprising:
a plurality of gauges;
an enclosure; and
wherein the enclosure is configured for mounting into a DIN stereo slot of the automobile.

20. The gauge cluster as recited in claim 19, further comprising at least one wire configured to provide electrical communication between at least one gauge of the gauge cluster and at least one sensor.

21. The gauge cluster as recited in claim 19, wherein the enclosure is configured for mounting within at least one of a 1″ high DIN stereo slot, a 1.5″ high DIN stereo slot, a 2″ high DIN stereo slot and a 3″ high DIN stereo slot.

22. The gauge cluster as recited in claim 19, wherein the enclosure is configured for mounting within a 2″ high DIN stereo slot.

23. The gauge cluster as recited in claim 19, wherein the gauge cluster comprises a voltage gauge, an oil pressure gauge, and a water temperature gauge.

24. The gauge cluster as recited in claim 19, further comprising at least one detent configured to inhibit removal of the gauge cluster from the DIN stereo slot.

25. The gauge cluster as recited in claim 19, further comprising at least one metallic leaf spring detent configured to inhibit removal of the gauge cluster from the DIN stereo slot.

26. The gauge cluster as recited in claim 19, further comprising at least one locking detent configured to inhibit removal of the gauge cluster from the DIN stereo slot.

27. The gauge cluster as recited in claim 19, further comprising at least one metallic leaf spring locking detent configured to inhibit removal of the gauge cluster from the DIN stereo slot.

28. The gauge cluster as recited in claim 19, further comprising at least one locking detent formed upon the enclosure thereof, the locking detent(s) comprising:
a leaf spring detent; and
a locking tab formed upon the leaf spring detent and configured to engage, a portion of an automobile DIN stereo slot such that the gauge cluster is locked into the DIN stereo slot when the leaf spring ‘detent’ is extended and such that the gauge cluster is not locked into the DIN stereo slot when the leaf spring detent is depressed.

29. The gauge cluster as recited in claim 19, wherein the gauge cluster comprises at least one gauge having a digital readout.

30. The gauge cluster as recited in claim 19, wherein the gauge cluster comprises a plurality of gauges having digital readouts.

31. The gauge cluster as recited in claim 19, further comprising at least one sensor that is electronically compatible with at least one gauge of the gauge cluster.

32. The gauge cluster as recited in claim 19, further comprising a bezel configured to limit movement of the gauge cluster into the DIN stereo slot.

33. The gauge cluster as recited in claim 19, further comprising a generally rectangular bezel configured to limit movement of the gauge cluster into the DIN stereo slot.

34. The gauge cluster as recited in claim 19, further comprising a generally oval bezel configured to limit movement of the gauge cluster into the DIN stereo slot.

35. A method for manufacturing a gauge cluster, the method comprising forming an enclosure of the gauge cluster that is configured for mounting within a DIN stereo slot of an automobile.

36. A locking detent for facilitating mounting a device within a DIN stereo slot of an automobile, the locking detent comprising:
a leaf spring detent; and
a locking tab formed upon the leaf spring detent and configured to engage a portion of an automobile DIN stereo slot such that the device is locked into the DIN stereo slot when the leaf spring detent is extended and such that the device is not locked into the DIN stereo slot when the leaf spring detent is depressed.

37. The locking detent as recited in claim 36, wherein the locking tab comprises a portion of the leaf spring which has been bent away from a remainder of the leaf spring.
